(19) United States
(12) Patent Application Publication
(10) Pub. No.: US 2014/0055341 A1
(43) Pub. Date: Feb. 27, 2014

(54) CONTROL SYSTEM AND METHOD THEREOF

(71) Applicant: HON HAI PRECISION INDUSTRY CO., LTD., New Taipei (TW)

(72) Inventors: CHUN-HUNG LAI, New Taipei (TW); CHIH-CHUN CHANG, New Taipei (TW)

(73) Assignee: HON HAI PRECISION INDUSTRY CO., LTD., New Taipei (TW)

(21) Appl. No.: 13/853,112

(22) Filed: Mar. 29, 2013

(30) Foreign Application Priority Data
Aug. 23, 2012 (CN) 201210302044.0

(51) Int. Cl. G06F 3/01

(52) U.S. Cl. CPC G06F 3/013
USPC 345/156

(57) ABSTRACT

A control system for controlling an external device based on images obtained by a control device comprises a detecting module, an obtaining module, and a determining module. The detecting module generates an obtaining signal when the control device establishes a communication with the external device. The obtaining module obtains an image of the current environment around the external device in response to the obtaining signal. The determining module determines whether at least one predefined object contained in the obtained image. When there is no predefined object contained in the obtained image, the determining module further determines whether the external device is in a first state and generates a first control signal when the external device is not in the first state. The external device switches to a first state for powering off the backlight of the external device in response to the first control signal.

### BACKGROUND

1. Technical Field

The present disclosure relates to control systems, particularly to a control system for switching the working states of an external device by a control device.

2. Description of Related Art

A television can display images or videos. The television further can switch to a standby or a shut down state according to a manual operation. However, the television may carelessly be left on when there is no audience viewing, thus electrical energy is wasted.

Therefore, there is room for improvement in the art.

### BRIEF DESCRIPTION OF THE FIGURES

Many aspects of the embodiments can be better understood with reference to the following drawings. The components in the drawings are not necessarily drawn to scale, the emphasis instead being placed upon clearly illustrating the principles of the control system and method thereof. Moreover, in the drawings, like reference numerals designate corresponding parts throughout the several views.

FIG. 1 is a block diagram of a control system in accordance with an embodiment.

FIG. 2 is a schematic diagram showing a control system of FIG. 1.

FIG. 3 is a flowchart of a control method in accordance with the embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

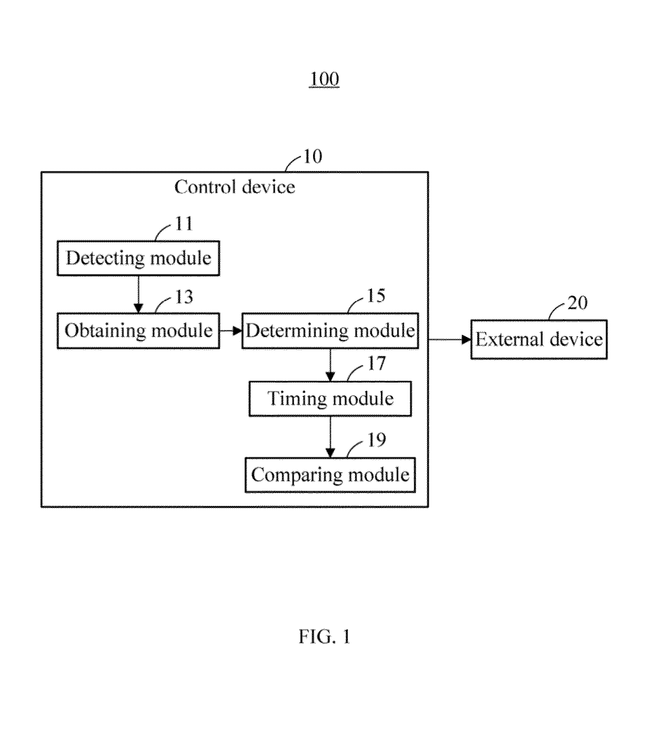

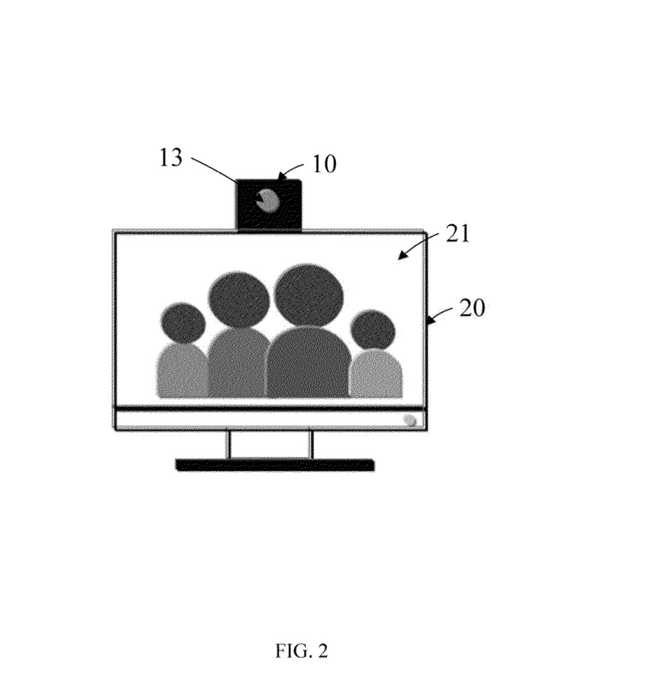

FIGS. 1 and 2 show a control system 100 of the embodiment. The control system 100 includes a control device 10 and an external device 20. The external device 20 includes a display 21 for displaying images or videos. The control device 10 obtains an image of the current environment around the external device 20, and switches the external device 20 to a first state or a second state based on the obtained image. In the embodiment, the control device 10 is a mobile phone; the external device 20 is a television; the first state is a standby state for powering off the backlight of the display 21 and the second state is a shut down state for completely powering off the whole external device 20.

The control device 10 includes a detecting module 11, an obtaining module 13, a determining module 15, a timing module 17, and a comparing module 19.

The detecting module 11 is used for generating an obtaining signal when the control device 10 establishes a communication with the external device 20. In the embodiment, the control device 10 as shown in FIG. 2 is directly inserted into a slot (not shown) on the top of the external device 20 for establishing a wired communication with the external device 20. In the other embodiment, the control device 10 is located adjacent to the external device 20 and wirelessly establishes a communication with the external device 20; the obtaining module 13 and the display 21 are facing to the same direction.

The obtaining module 13 obtains an image of the current environment around the external device 20 in response to the obtaining signal and generates a determining signal. In the embodiment, the obtaining module 13 is a camera of the control device 10.

The determining module 15 determines whether there is at least one predefined object contained in the obtained image. If there is no predefined object contained in the obtained image, the determining module 15 further determines whether the external device 20 is in the first state and generates a first control signal to the external device 20 and a timing signal when the external device 20 is not in the first state. In the embodiment, the predefined object is eyes or a face of human; the first control signal is transmitted to the external device 20 wired or wirelessly.

The timing module 17 records the time from the time point when the first control signal is generated in response to the timing signal.

The comparing module 19 compares the recorded time with a predetermined time. If the recorded time is less than the predetermined time, the comparing module 19 generates the obtaining signal; if the recorded time matches the predetermined time, the comparing module 19 generates a second control signal to the external device 20. In the embodiment, operators can adjust the predetermined time.

The external device 20 switches to the first state in response to the first control signal and switches to the second state in response to the second signal.

In other embodiments, one or more modules of the detecting module 11, determining module 15, timing module 17, and the comparing module 19 can be set in the external device 20.

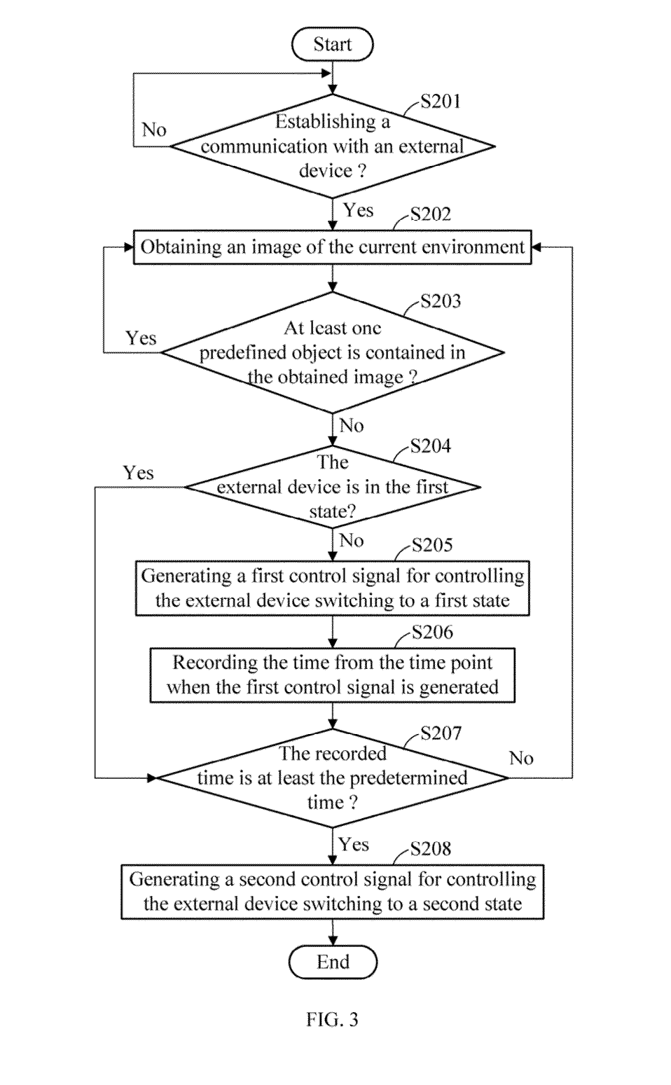

FIG. 3 shows a control method for switching the state of the external device 20 based on the obtained image of the control device 10. The control device 10 is capable of obtaining an image of the current environment. The external device 20 can switch to a first state or a second state. The external device 20 includes a display 21 for displaying images or videos. The control method includes the following steps.

In step S201, detecting whether the control device 10 establishes a communication with the external device 20. If the control device 10 establishes a communication with the external device 20, an obtaining signal is generated and the procedure goes to S202; if the control device 10 does not establish a communication with the external device 20, step S201 is repeated.

In step S202, in response to the obtaining signal the control device 10 obtains an image of the current environment and generates a determining signal. In the embodiment, the control device 10 obtains the image of the current environment around the external device 20 via the camera of the control device 10.

In step S203, determining whether there is at least one predefined object contained in the obtained image in response to the determining signal. If there is no predefined object contained in the obtained image, the procedure goes to S204; if there is at least one predefined object contained in the obtained image, the procedure goes to S202. In the embodiment, the predefined object is an eye or a face.

In step S204, determining whether the external device 20 is in the first state. If the external device 20 is in the first state, the procedure goes to S207; if the external device 20 is not in the first state, generating a first control signal and the procedure goes to S205.

In step S205, in response to the first signal the external device 20 is switched to the first state. In the embodiment, the first control signal is transmitted to the external device 20 wired. In the other embodiments, the first control signal is transmitted to the external device 20 wirelessly.

In step S206, recording the time from the time point when the first control signal is generated.

In step S207, comparing the recorded time with a predetermined time, if the recorded time matches the predetermined time, a second control signal is generated and the procedure goes to S207; if the recorded time is less than the predetermined time, the procedure goes to S202. In the embodiment, operators can adjust the predetermined time.

In step S208, in response to the second control signal the external device is switched to the second state. In the embodiment, the first state is a shut down state for powering off the external device 20; the second control signal is transmitted to the external device 20 in wired manner. In the other embodiments, the second control signal is transmitted to the external device 20 wirelessly.

In use, the control device 10 powers off the backlight of the display 21 when there is no viewers watching the external device 20, and further shuts off the external device 20 after no viewers watch the external device 20 for a predetermined time, such that consumption of electrical energy is reduced.

While various embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A control system for control an external device based on images obtained by a control device; the control system comprising:
a detecting module configured to generate an obtaining signal when the control device establishes a communication with the external device;
an obtaining module configured to obtain an image of the current environment around the external device in response to the obtaining signal; and
a determining module configured to determine whether at least one predefined object contained in the obtained image and generate a first control signal when there is no predefined object contained in the obtained image;
wherein when there is no predefined object contained in the obtained image, the determining module further determines whether the external device is in a first state and generates a first control signal when the external device is not in the first state; the external device switches to a first state for powering off the backlight of the external device in response to the first control signal.

2. The control system of claim 1, wherein the control system further comprises a timing module and a comparing module with a predetermined time; the timing module records time from the time point when the first control signal is generated; the comparing module compares the recorded time with the predetermined time; when the recorded time is at least the predetermined time, the comparing module generates a second control signal for switching the external device to a second state; the external device is completely powered off in the second state.

3. The control system of claim 2, wherein the predetermined time is adjustable.

4. The control system of claim 1, wherein the control device is inserted into a slot on the top of the external device.

5. The control system of claim 1, wherein the first control signal generated in the control device is transmitted to the external device wirelessly.

6. The control system of claim 1, wherein the predefined object is eyes of human.

7. A control device capable of communicating with an external device, the control device comprising:
a detecting module configured to generate an obtaining signal when the control device establishes a communication with the external device;
an obtaining module configured to obtain an image of the current environment around the external device in response to the obtaining signal; and
a determining module configured to determine whether at least one predefined object is contained in the obtained image;
wherein when there is no predefined object contained in the obtained image, the determining module further determines whether the external device is in the first state and generates a first control signal when the external device is not in the first state; the external device switches to a first state for powering off the backlight of the external device in response to the first control signal.

8. The control device of claim 7, wherein the control device further comprises a timing module and a comparing module with a predetermined time; the timing module records time from the time point when the first control signal is generated; the comparing module compares the recorded time with the predetermined time; when the recorded time is at least the predetermined time, the comparing module generates a second control signal for switching the external device to a second state; the external device is completely powered off in the second state.

9. The control device of claim 8, wherein the predetermined time is adjustable.

10. The control device of claim 8, wherein the first control signal and the second control signal is transmitted to the external device wirelessly.

11. The control device of claim 7, wherein the predefined object is a face of human.

12. The control device of claim 7, wherein the control device is inserted into a slot on the top of the external device.

13. A control method for controlling an external device based on images obtained by a control device, the control method comprising:
detecting whether the control device establishes a communication with the external device and generating an obtaining signal when the control device establishes a communication with the external device;
obtaining an image of the current environment around the external device in response to the obtaining signal;
determining whether there is at least one predefined object contained in the obtained image;
when there is no predefined object contained in the obtained image, determining whether the external device is in a first state; and
generating a first control signal for switching the external device to a first state for powering off the backlight when the external device is not in the first state.

14. The method according to claim 13, after the step of switching the external device to the first state in response to the first control signal further comprising:
recording the time from the time point when the first control signal is generated;
comparing the recorded time with a predetermined time and generating a second control signal when the recorded time matches the predetermined time; and
switching the external device to a second state for powering off the whole external device in response to the second control signal.

15. The method according to claim 14, wherein the predetermined time is adjustable.

16. The method according to claim 14, wherein when the recorded time is less than the predetermined time, generating the obtaining signal.

17. The method according to claim 13, wherein when there is at least one predefined object contained in the obtained image, generating the obtaining signal.

18. The method according to claim 13, wherein the control device is inserted into a slot on the top of the external device.

19. The method according to claim 13, wherein the predefined object eyes of human.
